(19) United States
(12) Patent Application Publication
(10) Pub. No.: US 2021/0166183 A1
(43) Pub. Date: Jun. 3, 2021

(54) METHOD AND APPARATUS FOR DECENTRALIZED INFORMATION MINING OF ONLINE CONTENT

(71) Applicant: YROO INC., Toronto (CA)

(72) Inventor: Qi ZHU, Toronto (CA)

(21) Appl. No.: 17/057,215

(22) PCT Filed: May 22, 2019
(86) PCT No.: PCT/CA2019/050693

§ 371 Date: Nov. 20, 2020

Related U.S. Application Data
(60) Provisional application No. 62/675,272, filed on May 23, 2018.

(51) Int. Cl. G06Q 10/06; G06F 16/2458; G06F 9/54; G06Q 50/18

(52) U.S. Cl. CPC G06Q 10/06398; G06F 16/2465; G06F 2216/03; G06Q 50/18; G06F 9/547

(57) ABSTRACT

A method and apparatus for decentralized information mining of online content is described. The method includes issuing a contract for completion by users. Once results are received, the system determines if the results include an expected piece of data. If so, the results are then determined be eligible for compensation and are passed to a compensation module to determine if the miner is eligible for compensation for completion of the contract.

### CROSS-REFERENCE TO OTHER APPLICATIONS

The current disclosure claims priority from U.S. Provisional Application No. 62/675,272 filed May 23, 2018 which is hereby incorporated by reference.

### FIELD

The disclosure is generally directed to the field of online information retrieval and, more specifically, to a method and apparatus for decentralized information mining of online content.

### BACKGROUND

In order to find information online, users access search engines to retrieve the requested information. These search engines then take the search string entered by the user and uses this string to retrieve information that it believes the user is interested in accessing. However, the data that is returned may or may not be useful to the user. In some scenarios, the data that is returned may be out of date or may be incorrect.

Currently, search engine technology tends to retrieve online content on a periodic basis, typically weekly or monthly whereby the content being retrieved tends to be out-of-date. Also, with some currently search engine crawlers, only shallow content is retrieved from websites. In most cases, current search engine crawlers are unable to interact with website forms, the search bar and/or other user interface components that may include valuable or beneficial content as they are usually hidden behind these user interface components.

Therefore, there is provided a novel method and system for decentralized information mining of online content.

### SUMMARY

The disclosure is directed at a method and system for decentralized information mining of online content. The system and method take advantage of the resources of users who agree to allocate a portion of their computer resources for third-party use. When users allow their computers (more specifically, their browsers and mobile devices) to enter a mining mode, thereby initiating a browser/mobile miner, the method and system of the disclosure can issue contracts that can be fulfilled by these “browser miners”.

In one embodiment, the disclosure provides a system and method of determining the accuracy of the information mined by individual miners. In another embodiment, the disclosure provides a system and method of determining if a browser miner has fulfilled the contract.

In a further embodiment, the disclosure provides a method and system for compensating browser miners (or more accurately, the users that allocate their computer resources for information mining) for completion and/or accuracy of completion of contracts.

In a further embodiment, the disclosure provides a method and system for ranking browser miners based on their performance with respect to previous contracts that have been completed.

In one aspect of the disclosure, there is provided a method for decentralized mining of online content including issuing a contract to a plurality of miners; receiving results from the plurality of miners; and determining which of the plurality of miners should be compensated based on the received results.

In another aspect, after receiving results from the plurality of miners: comparing the results with expected data; determining which of the results include the expected data; and determining miners associated with results that include the expected data are eligible for compensation. In a further aspect, the method further includes compensating the miners associated with results that include the expected data. In yet another aspect, compensating the miners associated with results that include the expected data includes comparing the results from each of the miners associated with results that include the expected data with each other; using consensus protocol to determine which of the miners have a highest accuracy; and compensation the miners that have the highest accuracy with respect to their results. In another aspect, issuing a contract includes receiving a contract from an authority node; and broadcasting the contract to the plurality of miners. In an aspect, after issuing the contract, the method further including receiving an API call from at least one of the plurality of miners; and responding to the API call with instructions to the at least one of the plurality of miners. In yet another aspect, before issuing the contract, the method further including determining the plurality of miners that are eligible for performing the contract. In another aspect, after receiving the results, the method further including determining which of the miners within the plurality of miners is eligible for performing the contract. In yet another aspect, determining miners associated with results that include the expected data incudes determining a quorum of miners associated with results that include the expected data.

In another aspect of the disclosure, there is provided one or more non-transitory computer-readable storage media having collectively stored therein instructions that, if executed by one or more processors of a computer system, cause the computer system to at least issue a contract to a plurality of miners; receive results from the plurality of miners; and determine which of the plurality of miners should be compensated based on the received results.

In another aspect, the system further includes instructions that, if executed, cause the computer system to compare the results with expected data; determine which of the results include the expected data; and determine miners associated with results that include the expected data are eligible for compensation. In yet another aspect, the system further includes instructions that, if executed, cause the computer system to compensate the miners associated with results that include the expected data. In yet a further aspect, wherein to compensate includes comparing the results from each of the miners associated with results that include the expected data with each other; using consensus protocol to determine which of the miners have a highest accuracy; and compensation the miners that have the highest accuracy with respect to their results.

In another aspect, issuing a contract includes receiving a contract from an authority node; and broadcasting the contract to the plurality of miners. In yet another aspect, the system further includes instructions that, if executed, cause the computer system to receive an API call from at least one of the plurality of miners; and respond to the API call with instructions to the at least one of the plurality of miners. In a further aspect, the system further includes instructions that, if executed, cause the computer system to determine the plurality of miners that are eligible for performing the contract. In yet a further aspect, the system further includes instructions that, if executed, cause the computer system to determine which of the miners within the plurality of miners is eligible for performing the contract.

In yet another aspect, determining miners associated with results that include the expected data includes determining a quorum of miners associated with results that include the expected data.

### DESCRIPTION OF THE DRAWINGS

Embodiments of the present disclosure will now be described, by way of example only, with reference to the attached Figures.

FIG. 1a is a schematic diagram of a system for decentralized information mining of online content;

FIG. 1b is a schematic diagram of another embodiment of a system for decentralized mining of online content;

FIG. 2 is a schematic diagram of a server for use in a system for decentralized information mining of online content;

FIG. 3a is a flowchart outlining one method of decentralized information mining of online content;

FIG. 3b is a flowchart outlining another method of decentralized information mining of online content;

FIG. 4 is a flowchart outlining a method of determining if miners have completed a contract;

FIG. 5 is a flowchart outlining a method of determining accuracy of the information mined by a miner with respect to a contract;

FIG. 6 is a flowchart outlining method of a user performing decentralized information mining of online content;

FIG. 7 is a flowchart outlining a method of ranking miners; and

FIG. 8 is a flowchart outlining another method of examining results.

### DETAILED DESCRIPTION OF THE EMBODIMENTS

The disclosure is directed at a method and system for decentralized information mining of online content. In one embodiment, the disclosure is directed at a system and method of determining whether or not a decentralized information mining request, typically in the form of a contract, is performed. In another embodiment, the disclosure is directed at a system and method of determining the accuracy of the results from a decentralized information mining request. In yet another embodiment, the disclosure is directed at a system and method for rating the performance of users/browser miners that are fulfilling the decentralized mining requests.

In a preferred embodiment, the disclosure finds benefit when used within a block-chain architecture.

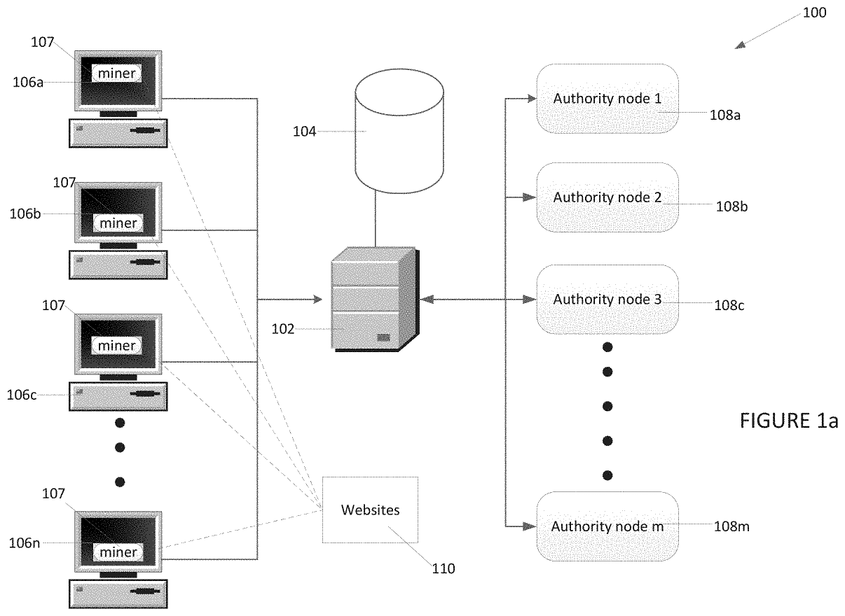

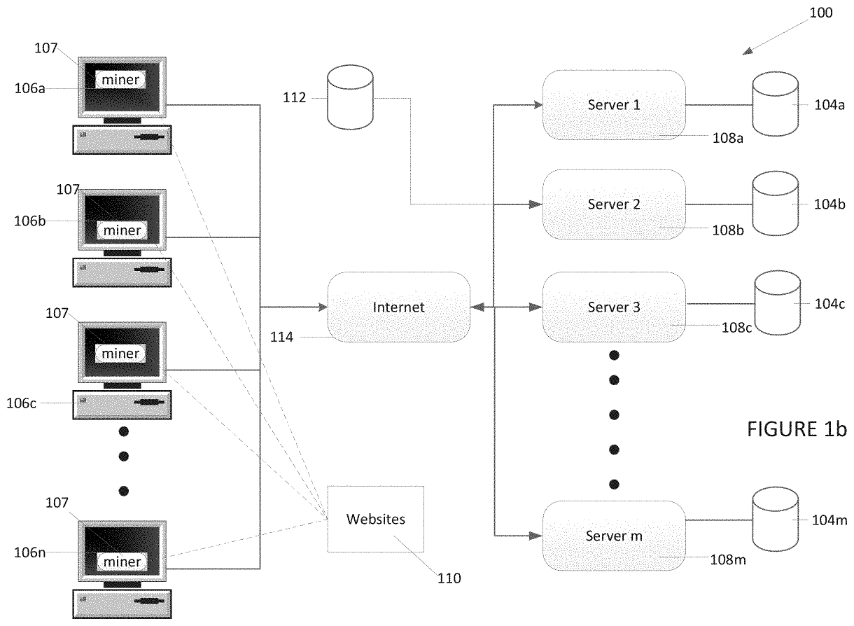

Turning to FIG. 1a, a schematic diagram of a system for decentralized information mining of online content is shown. Among other functionality, the system may also be used for reviewing contract fulfillment and/or determining accuracy of contract fulfillment. The system 100 includes a server 102 that is in communication with, or operatively communicable with, a database 104 that may store various information, including but not limited to, contracts, miner information, miner reputation lists, authority node information, collected data etc. This information may be stored in the database or, if a blockchain is maintained by a set of authority nodes, then stored directly on or in the blockchain.

Users (seen as user devices, or computers, 106a to 106n) are connected to the server 102 in order to participate in the receipt and/or fulfillment of contracts. User devices may include, but are not limited to, desktop computers, laptops, handheld mobile devices, tablets, Smartphones and the like.

In order to participate in a contract, the user agrees to allocate user device resources to perform decentralized data mining. Users typically allocate computer resources, such as via their browser, to allow mining of online content to be performed. The allocated computer resources may be seen as data miners 107. For users that are using computers, such as the desktop computer, laptops or tablets, the miner may be executed or implemented within a browser and seen as a browser miner. For mobile phones, such as Smartphones, the system may be executed or implemented in an application, or app and seen as an app miner. It will be understood that the browser miner and the app miner perform the same functions and operate in an identical manner. In a further embodiment, a secured “sandbox” environment can be created to execute the contract in order to protect user privacy. In the current figures, it will be understood that “n” and “m” represents any number.

The server 102 may also be in communication with individual authority nodes 108 (seen as authority node 1 to m). The authority nodes 108 may be seen as the entities that issue the contracts for completion by the browser miners 107 and are preferably integrated within a block chain architecture. The authority nodes 108 may also perform the necessary functions to determine fulfillment of contracts or accuracy of the fulfillment of contracts. This will be described in more detail below. In a preferred embodiment, these functions are performed by the server 1102 with input from the authority node that issued the contract.

The contracts that are issued by the authority nodes 108 require the miners to access websites 110 to mine the online content. Each contract includes compensation associated with completion or fulfillment of the contract, such as in the form of, but not limited to, a cryptocurrency payment, loyalty points, a bounty or services. These contracts may include requirements, such as, but not limited to, to retrieve product and price information from merchant websites, weather information from weather office websites, statistics from sports websites and the like. Alternatively, the contracts may include advertisement creative and financial products like credit card information or mortgage rates information that is retrieved from websites 110.

In one embodiment, this may be seen as a partially closed system whereby new users can enter the system, however new authority nodes may not be allowed to enter the system unless they are authorized by a majority of other authority nodes already in the system. This allows the block chain architecture or structure to be maintained. As will be understood, the block chain architecture allows information to be controlled whereby the authority nodes within the block chain architecture are the keepers of the information. The authority nodes may control how information blocks are created and also controls the cryptocurrency within the block chain architecture.

Turning to FIG. 1b, a second embodiment of a system for decentralized information mining of online content is shown. In the current embodiment, the system 100 includes a set of users 106a to 106n that communicate with a set of servers 108a to 108m. As with FIG. 1, it will be understood that “n” and “m” may be any number.

Each of the servers 108a to 108m is associated with a database 104a to 104m that may store information associated with the server 108a to 108m. In the current embodiment, the servers 108 may be seen as the entities that issue the contracts for completion by the users, such as via their miners 107. The system may further include a general database 112 that stores information relating to the miners and their performance (such as disclosed above).

In the current embodiment, the individual databases store the contract information along with other information as outlined above. In the current embodiment, communication between the servers and users is preferably via a network (such as the internet 114). In the discussion below, use of the word “authority node” and “server” may be used interchangeably whereby both may generally be seen as contract issuing authorities along with entities able to determine contract fulfillment and the like.

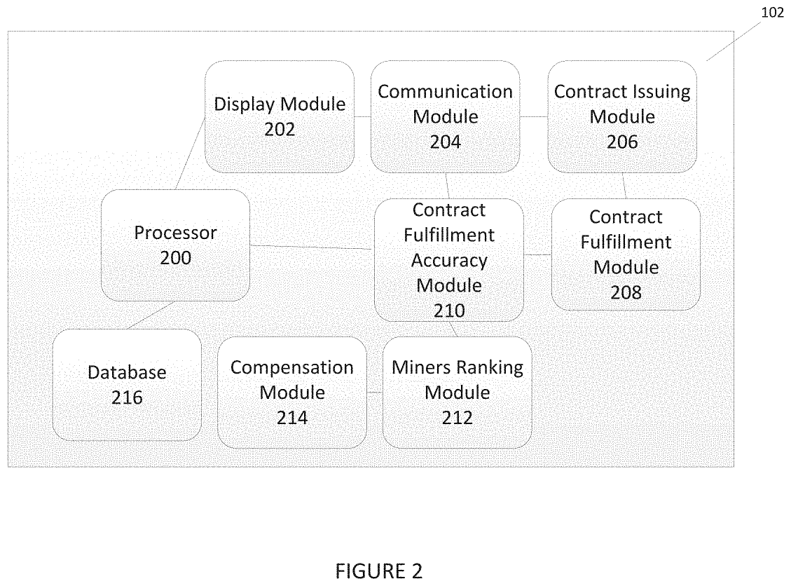

Turning to FIG. 2, a schematic diagram of a server is shown. The server may be either the server 102 in FIG. 1a or one of the servers 108a in FIG. 1b. Each server includes a processor 200 that controls a plurality of modules that assist to implement the method and system of decentralized mining of online content. The plurality of modules may include, but are not limited to, a display module 202, a communication module 204, a contract issuing module 206, a contract fulfillment module 208, a contract fulfillment accuracy module 210, a miner ranking module 212 and a compensation module 214. Although shown in one server, it will be understood that the modules may be housed in different servers, with the ability to interact with each other. It is also understood that an embodiment of the server may include only some of the modules depending on the requirements of the system. A database 216 (or the database 104) may also be included within the server 102.

In one embodiment, the display module 202 operates to transmit images, or screens, that are displayed on the user devices 106. For instance, the display module 202 may generate screens for display to a user. These screens may include, but are not limited to, a listing of the contracts available or a listing of the requirements of a specific contract. The display module 202 may also perform the necessary actions to convert images from other modules into a format that is viewable on the user's particular device. The communication module 204 includes the firmware, such as apparatus, components or software, for the server 102 to communicate with the user devices 106. In a preferred embodiment, the communication is performed wirelessly, however, a wired connection may also be used. Wireless communication may be via any known telecommunication networks and therefore, the components with the communication module 104 may be any components that enable wireless or wired communication with any one of the user devices 106 (or authority nodes 108 in the FIG. 1a embodiment).

The contract issuing module 206 may operate to receive contracts from authority nodes (FIG. 1a) or may generate the contract (FIG. 1b), or to retrieve them from the database 216, and to then issue those contracts to users who are interested in allocating computer resources to perform decentralized mining of online content. The contract issuing module also retains all of the information that associates which user has been issued which contract. In one embodiment, a contract includes links to websites that the authority nodes (FIG. 1a) or that itself (FIG. 1b) wishes to have information (or online content) mined from. The miner is typically requested to mine the information from the identified websites to return specific information that the contract has listed as a requirement.

In one embodiment, the contract fulfillment module 208 performs the function to confirm that a miner has completed the contract. In one embodiment, the contract fulfillment module 208 may assist to protect user privacy such as by implementing and controlling a “sandbox” environment. The contract fulfillment module may receive the results from individual miners and then compare the results with expected result to determine if the miner has fulfilled a portion of the contract and that they are eligible for compensation. The contract fulfillment module 280 may also determine if the miner deserves to be compensated for their mining and may communicate with the compensation module 214, as necessary.

In one embodiment, the contract fulfillment accuracy module 210 performs the functionality of determining the accuracy of the results provided by the miner as a result of their decentralized mining of online content as outlined by the contract. Based on the accuracy of the results received from the miners, the contract fulfillment accuracy module 210 may then determine if any, or all, of the miners that completed the contract deserve compensation. If so, the contract fulfillment accuracy module 210 communicates with the compensation module 214 to compensate the miners. In a further embodiment, the accuracy may be determined by consensus protocol.

The compensation module 214 compensates the users (based on information from the other modules), preferably in the form of cryptocurrency, services, loyalty points and the like.

The miners ranking module 212 may rank miners based on the completion of contracts and the accuracy of completion of contracts using information from the contract fulfillment module 208 and the contract fulfillment accuracy module 210. The ranking of the miners may assist authority nodes in determining which miners to issue future contracts.

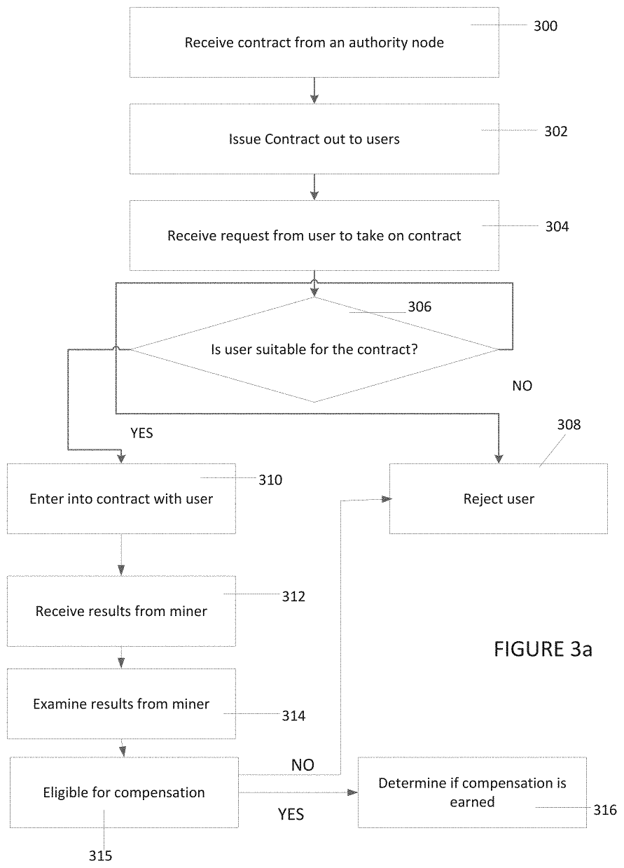

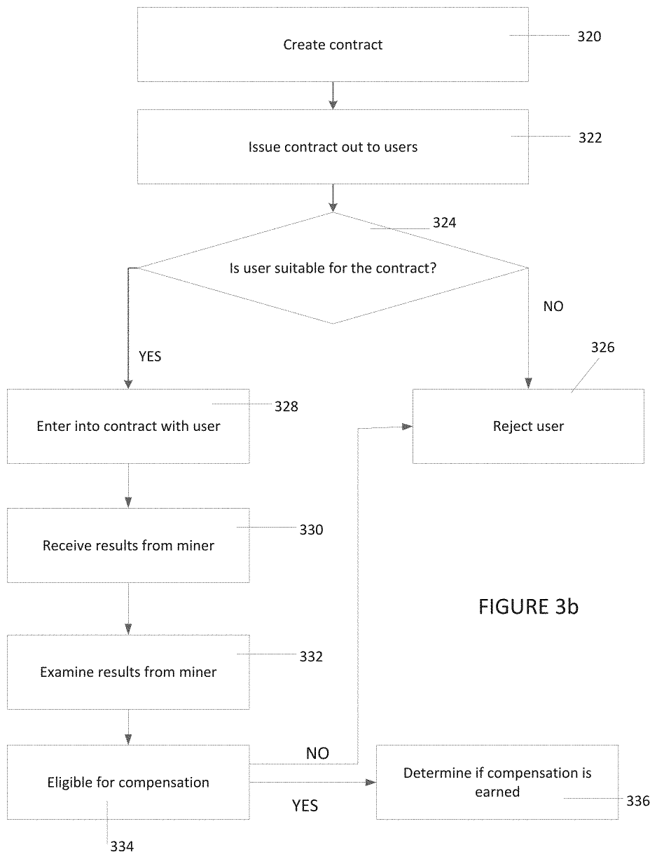

Turning to FIG. 3a, a flowchart outlining an embodiment of decentralized mining of online content for use in the system of FIG. 1a is shown. Initially, a contract is received from one of the authority nodes (300). The contract is then issued or sent out to find users that are interested in taking on the contract (302). Users can then submit a request to take on the contract or may simply allocate resources on their computer to take on the contract. As described above, this may be in the form of a browser miner or an app miner. The request or indication that a user is interested in taking on the contract is then received by the system (304).

The system then determines if they wish to enter into the contract with the requesting miner and/or the user (306) by determining if the user/miner 106/107 is suitable for the contract. In some cases, such as based on a miner's ranking, the system (or authority node) may not wish to enter into a contract with a specific user. Alternatively, the system may determine that the user has not allocated enough resources to complete the contract in a reasonable time frame. Other reasons for not wishing to enter into an agreement with a user are possible. If this is the case, the user is rejected (308). Otherwise, the system can enter into a contract with the user (310). The miner can then go and perform the necessary mining activities (as outlined by the contract) and then return the results to the system (312).

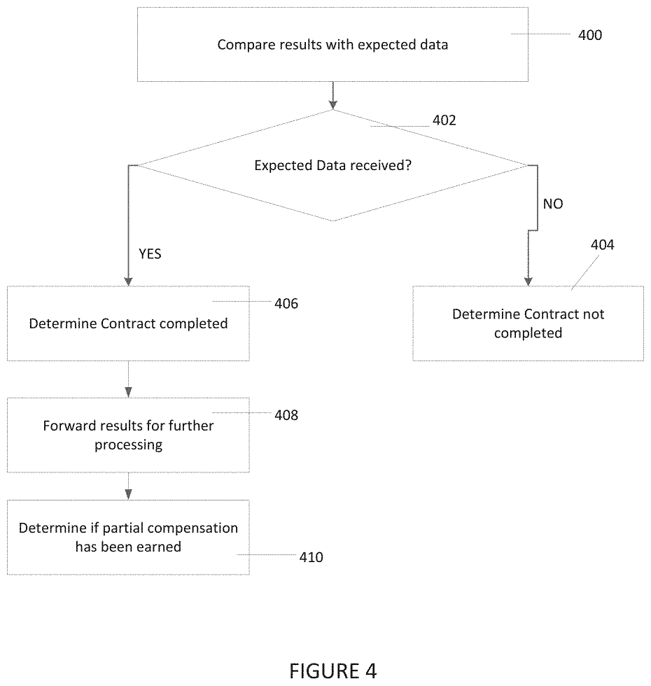

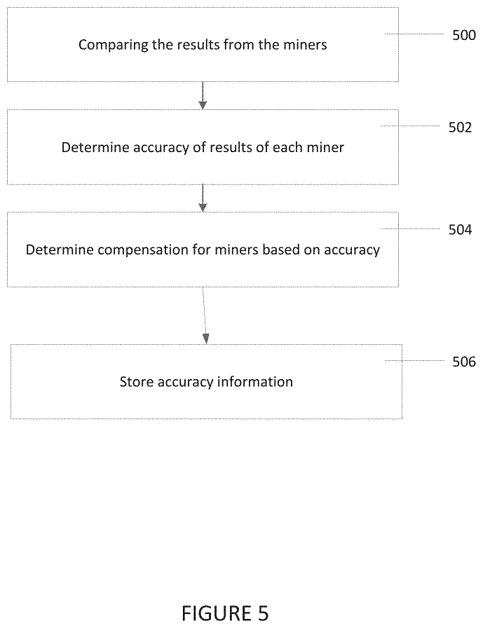

After receiving the results, the results may be examined (314). Based on the examination, it may be determined if the user is eligible for compensation (315). A method of determining if a user is eligible for compensation is described with respect to FIG. 4. If the user is not eligible, the contract is cancelled with the user and it may be seen as if the user has been rejected (308). If the user is eligible for compensation, the system determines if compensation has been earned (316). One method of determining if compensation is earned is schematically shown in FIG. 5.

Turning to FIG. 3b, another flowchart outlining a method of decentralized mining of online content for use with the system of FIG. 1b is shown. Initially, a contract is created by one of the servers (320). The contract is then issued to all of the users (322). In an alternative embodiment, the contract may be issued to a subset of the users based on predetermined criteria whereby it is assumed that each of the users that are issued the contract are eligible for fulfilling the contract.

Once the contract is issued, the system then determines if the user 106 is suitable for the contract (324). If not, the user is rejected (326). If so, the system enters into a contract with the user (328).

The results from the miners that are interested in fulfilling the contract are then received (330) and examined (332).

In one embodiment, after the results are examined, the system may determine if the miner is eligible for compensation (334). A method of determining if a user is eligible for compensation is described with respect to FIG. 4. If the user is not eligible, the contract is cancelled with the user and it may be seen as if the user has been rejected (326). If the user is eligible for compensation, the system determines if compensation has been earned (336). One method of determining if compensation is earned is schematically shown in FIG. 5.

To determine if a user is eligible for compensation, in one embodiment, a comparison may be performed to determine if the miner has completed a specific task in the contract such as shown and described in FIG. 4.

Turning to FIG. 4, a flowchart outlining a method of determining if a user (or miner) is eligible for compensation is shown. In this embodiment, the method is directed at confirming that a miner has performed the requirements of the contract. This may be performed by the contract fulfillment module. For instance, the contract, or job, may be to retrieve or mine the information from ten different websites or links. In order to confirm, or somewhat confirm, that the miner has performed its task, one of the links, or websites, listed in the contract is preferably controlled by the authority node (or server) that issued the contract. In this manner, the authority node (or server) has data that it expects to see in the results. This may be seen as expected data. It is assumed that the contract fulfillment module also knows this information.

In this manner, the contract fulfillment module can compare the results received from the miner with the expected data (400) from the website controlled by the authority node or server. Prior to this, the system may also perform a check to determine that the contract requirements have been completed. For instance, if the results from 10 websites has been requested, the system may check to see if 10 results have been received. The system can then determine if the expected data is in the results (402). If the expected data is not seen in the results, it can confirm that the miner did not complete the task (404) and is therefore not eligible for compensation. If the expected data is found in the results, the system can confirm that the miner likely completed the task (406) and is eligible for compensation. The remaining results from the eligible miner is then forwarded for further processing (408). As will be understood, this method provides a mechanism for the system to determine if the task, or contract was performed correctly, but does not provide any indication as to the accuracy of the results that were provided by the miner, such as with respect to the information retrieved from the other links that are associated with websites not controlled by the authority node (or server). Based on this information, the contract fulfillment module can then instruct the compensation module to issue partial compensation (410), if it is required. Alternatively, compensation may not be awarded until all the results are processed.

Turning to FIG. 5, a flowchart outlining another method of how the results may be examined is shown. In some embodiments, the authority nodes (or server) may perform a consensus calculation to see if the majority of the miners agree to a same set of results whereby only miners that produced results conforming to the majority that forms the quorum get rewarded at the end.

In the current embodiment, it is assumed that the contract has been issued out to at least three miners or that at least three miners have submitted results based on the issued contract. More preferably, it is preferred that the contract be issued to more than 10 miners so that the determination of accuracy can be improved. As before, it is assumed that the contract includes a requirement for each miner to mine online content from multiple websites, for example one hundred (100) websites. Each selected miner is then provided the links (such as in the form of websites) from which the individual miners are requested to retrieve or mine information. Each set of information retrieved from a website may be seen as an information block.

Once the results from all of the eligible miners are received, the contract fulfillment accuracy module can then compare the results from each the miners with each other (500). In one embodiment, the information blocks from each website for each miner are compared with each to see how many are identical with each other. For those that are identical, it is determined that the miner accurately retrieved the information from that website. For those that are not identical to the majority of the information blocks, it can be seen that the miner did not accurately mine the information. This may be seen as the consensus calculation.

If the contract included a hundred websites, then the hundred blocks for each miner are compared with the hundred blocks from the other eligible miners. If the information block is identical to the majority of other information blocks for a specific website, the miner may be given a score of one, with the possibility to scoring a maximum of 100 points out of 100 websites.

In this manner, the system, or contract fulfillment accuracy node, can determine the accuracy or the results from each miner (502). The compensation for the miners may then be determined (504). This may be performed by the contract fulfillment accuracy module or may be determined by any of the other modules based on information from contract fulfillment accuracy module. Contracts typically are associated with a bounty or payment. This payment may be used to compensate one or more than miners after a contract has been completed. In some cases, contracts may be issued to more than one miner whereby the bounty may be shared between one, some or all of the miners. One method of payment may be 50% of the bounty to the most accurate miner and then the remaining 50% to the rest of the miners. Another method of payment may be to compensate the top 10 most accurate miners with 10% of the bounty. In another embodiment, the bounty may be used to compensate the most accurate miner with 50% of the bounty, the second most accurate miner with 30% of the bounty and the third most accurate miner with 20% of the bounty. In some cases, only the most accurate miner gets compensated for completing the contract. Alternatively, the top predetermined number of miners may be compensated for completing the contract based on their accuracy or the number of miners that achieve a predetermined accuracy rating may be compensated for completion of the contract. Other manners of compensating miners may be contemplated.

The accuracy information can then be stored (506) so that it may be used by other modules, such as the ranking miners module.

Although shown and discussed separately, the methods of FIGS. 4 and 5 may be performed together, concurrently or consecutively.

One advantage of the current system is that compensation may be based on accuracy rather than speed. Instead of rewarding miners that are the quickest (maybe based on having more resources allocated by the user), the miner that retrieves the most accurate results is compensated. It will be understood that the contract may include a limitation of the time period in which the data mining is to be completed so being accurate and slow may not necessarily be compensated. The details are preferably outlined in the contract and differ depending on the requirements of each individual authority node or server.

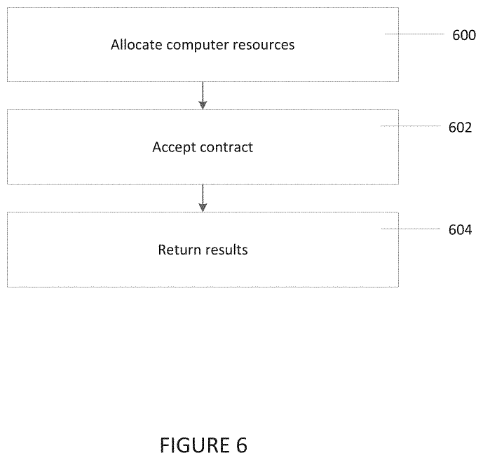

Turning to FIG. 6, a flowchart outlining actions a user may take in order to generate a data miner is shown. Initially, it is assumed that the user is online. The user can allocate computer resources for mining (600). In one embodiment, the flowchart may be seen as a method of browser based information mining. Alternatively, the mining may be performed by an app miner.

The data miners can then be eligible for accepting contracts issued by authority nodes (or by the server). After accepting a contract (602), the browser or app miner completes the tasks outlined in the contract with or without any input from the user. It will be understood that this can be performed automatically once the contract has been accepted by the user or the user has decided to allocate resources to fulfill the contract. In another embodiment, to protect user privacy, a secure “sandbox” environment may be generated or implemented before the contract is executed. Alternatively, the user may be required to provide some input such that the data miner can then complete the contract. Once the miner has mined all of the websites in the contract to retrieve the required information, the results are then returned to the server, or one of the modules in the server (604). The data miner (or user) may then be compensated for its work in fulfilling the contract (such as outlined above).

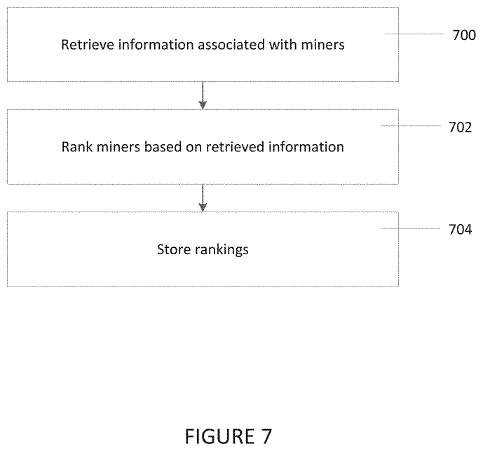

Turning to FIG. 7, a flowchart outlining a method of ranking miners is shown. This may be beneficial in assisting either the server, or authority nodes, to determine which miners to which contracts should be issued. In this manner, the miners having certain characteristics can be selected for specific contracts. Examples of characteristics include, but are not limited to, how many contracts fulfilled, how many contracts correctly fulfilled, accuracy of results for contracts fulfilled, fastest contract fulfilled and/or most contracts fulfilled.

It is preferable to use a separate block chain architecture for this ranking as monitoring miner ranking and performance so that all authority nodes (not just those in the block chain architecture of FIG. 1a) can access this information. As will be understood, users can allocate resources for any block chain architecture and do not necessarily have to be associated with only one block chain. As such, it will be beneficial in providing these rankings and performance metrics to other authority nodes that may be issuing contracts for mining of online content.

Initially, the system retrieves information associated with the miners (700). In one embodiment, the ranking miners module may retrieve information from the database that stores the determinations from the different modules, such as the contract fulfillment module or the contact fulfillment accuracy module. Alternatively, the contract fulfillment information and/or the accuracy information may be retrieved from the individual modules.

The ranking miners module can then rank the performance of the miners based on predetermined criteria (702). As will be understood, the miners can be ranked on any number of different criteria such as those listed above. The ranking miners module can then store the rankings in a designated location (704), preferably either within or external to the block chain architecture in which the ranking miners module resides. Alternatively, the ranking miners module can also store the rankings both within and external to the block chain architecture.

In another embodiment, the system may include a further block chain architecture to store or provide the information that is mined by the miners. For instance, if the information being mined relates to products available for sale on the Internet, this block chain architecture may be seen as an information block chain architecture. As such, after the information (or results) are verified, such as by the contract fulfillment accuracy module, this information can then be posted on the information block chain.

For instance, such as in the embodiment disclosed above with respect to the FIG. 5, with the 100 information blocks for each website, the system can select the most common information block (the one used to determined accuracy) for each website and then provide this information block to the information block chain for storage and/or display. As such individuals, or nodes, outside the block chain can access the information that has been mined on behalf of the authority nodes of the block chain. The information that is displayed to the external individuals may include information associated with the miners that mined the content or show the verification parameters that were used to confirm accuracy of the content.

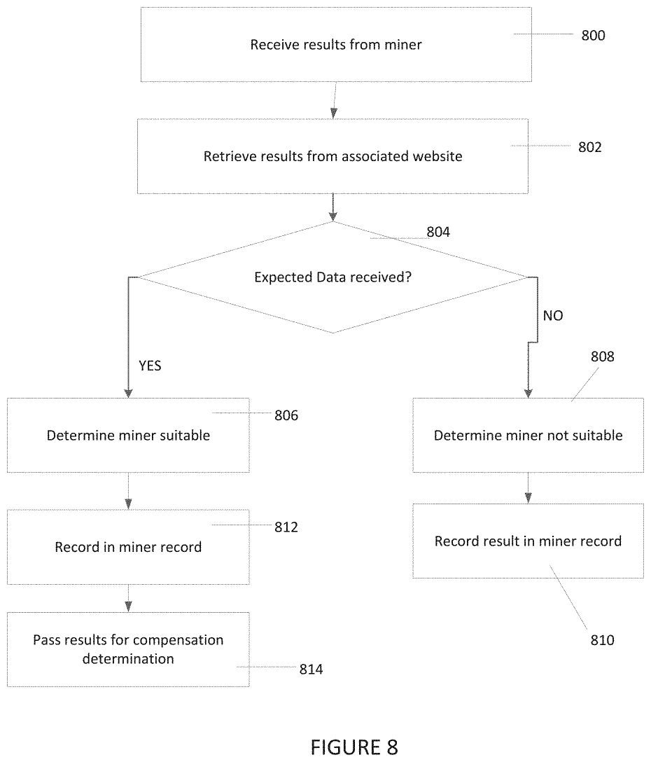

Turning to FIG. 8, a flowchart outlining a second method of contract validation is shown. In the current example, the contract requires a miner to retrieve information from ten (10) websites. Within the list of ten websites, one of the websites is associated or controlled by the server issuing the contract. As such, the system is aware of the information that is contained within the website and knows the content that should be returned by the miner if the miner has correctly performed the contract instructions for this website.

After issuing the contract and receiving results from a miner (800), the server or system then retrieves the results from the miner associated with the website that is controlled by the server (802). These results are then compared with the expected values to determine if the expected data has been received (804). If the received results are the same as, or include, the expected values, the miner is then determined to be suitable (806) and, if not, the miner is determined to not be suitable (808). If the miner is determined to not be suitable, then this is recoded in the miner's record within the system (812).

If the miner is determined to be suitable, this is also recorded in the miner's record within the system (812). The miner's results are then passed (814) to the system for determination if the miner is eligible for compensation.

In one embodiment, it will be understood that the results received from a user may be performed in an automated manner by the miner or may be generated based on user interaction, however, it will be understood that the results received from the miner are the more critical and that it does not matter how the user or miner retrieved those results.

In one embodiment, if the data mining is automated by the user, the miner may interact with an application programming interface (API) such as one provided by the system to assist in the processing of information from websites. The API may provide further instructions to the miner such as the type of information to extract from a website. Information may include, but is not limited to, price, location, obtaining screen shot, regular expression (string matching), a cropped image or source code. In this manner, the contract instructions may include: 1) visit a specific website; 2) search a specific product; 3) retrieve source code; 4) call an API; 5) visit website associated with API call; and 7) obtain a screen shot of the website associated with the API call.

In an alternative embodiment, the system may limit the number of miners that are determined to be eligible for compensation. For instance, if the contract is issued and there are 300 results received, the system may deem the first 100 miners that included the expected data (FIG. 4) eligible for compensation. Furthermore, there may be a quorum size required for compensation whereby if there are not enough miners eligible for compensation, the contract may be re-issued for more miners to join until a quorum of miners is reached for the compensation (consensus) process (FIG. 5).

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method for decentralized mining of online content comprising:
issuing a contract to a plurality of miners;
receiving results from the plurality of miners; and
determining which of the plurality of miners should be compensated based on the received results.

2. The method of claim 1 further comprising, after receiving results from the plurality of miners:
comparing the results with expected data;
determining which of the results include the expected data; and
determining miners associated with results that include the expected data are eligible for compensation.

3. The method of claim 2 further comprising:
compensating the miners associated with results that include the expected data.

4. The method of claim 3 wherein compensating the miners associated with results that include the expected data comprises:
comparing the results from each of the miners associated with results that include the expected data with each other;
using consensus protocol to determine which of the miners have a highest accuracy; and
compensation the miners that have the highest accuracy with respect to their results.

5. The method of claim 1 wherein issuing a contract comprises:
receiving a contract from an authority node; and
broadcasting the contract to the plurality of miners.

6. The method of claim 1 further comprising, after issuing the contract,
receiving an API call from at least one of the plurality of miners; and
responding to the API call with instructions to the at least one of the plurality of miners.

7. The method of claim 1 further comprising, before issuing the contract;
determining the plurality of miners that are eligible for performing the contract.

8. The method of claim 1 further comprising, after receiving the results;
determining which of the miners within the plurality of miners is eligible for performing the contract.

9. The method of claim 2 wherein determining miners associated with results that include the expected data comprises:
determining a quorum of miners associated with results that include the expected data.

10. One or more non-transitory computer-readable storage media having collectively stored therein instructions that, if executed by one or more processors of a computer system, cause the computer system to at least:
issue a contract to a plurality of miners;
receive results from the plurality of miners; and
determine which of the plurality of miners should be compensated based on the received results.

11. The one or more non-transitory computer-readable storage media of claim 10 further comprising instructions that, if executed, cause the computer system to:
compare the results with expected data;
determine which of the results include the expected data; and
determine miners associated with results that include the expected data are eligible for compensation.

12. The one or more non-transitory computer-readable storage media of claim 10 further comprising instructions that, if executed, cause the computer system to:
compensate the miners associated with results that include the expected data.

13. The one or more non-transitory computer-readable storage media of claim 12 wherein to compensate comprises:
comparing the results from each of the miners associated with results that include the expected data with each other;
using consensus protocol to determine which of the miners have a highest accuracy; and
compensation the miners that have the highest accuracy with respect to their results.

14. The one or more non-transitory computer-readable storage media of claim 10 wherein to issue a contract comprises:
receiving a contract from an authority node; and
broadcasting the contract to the plurality of miners.

15. The one or more non-transitory computer-readable storage media of claim 10 further comprising instructions that, if executed, cause the computer system to:
receive an API call from at least one of the plurality of miners; and
respond to the API call with instructions to the at least one of the plurality of miners.

16. The one or more non-transitory computer-readable storage media of claim 10 further comprising instructions that, if executed, cause the computer system to:
determine the plurality of miners that are eligible for performing the contract.

17. The one or more non-transitory computer-readable storage media of claim 10 further comprising instructions that, if executed, cause the computer system to:
determine which of the miners within the plurality of miners is eligible for performing the contract.

18. The one or more non-transitory computer-readable storage media of claim 11 wherein to determine miners associated with results that include the expected data comprises:
determining a quorum of miners associated with results that include the expected data.
